(19) United States
(12) Patent Application Publication
(10) Pub. No.: US 2026/0357366 A1
(43) Pub. Date: Nov. 12, 2026

(54) GRAIN-ORIENTED ELECTRICAL STEEL SHEET

(71) Applicant: NIPPON STEEL CORPORATION, Tokyo (JP)

(72) Inventors: Hisashi MOGI, Tokyo (JP); Masataka IWAKI, Tokyo (JP); Naoki WADA, Tokyo (JP); Masaru TAKAHASHI, Tokyo (JP)

(73) Assignee: NIPPON STEEL CORPORATION, Tokyo (JP)

(21) Appl. No.: 19/131,747

(22) PCT Filed: Nov. 22, 2023
(86) PCT No.: PCT/JP2023/042012

§ 371 Date: May 21, 2025

(30) Foreign Application Priority Data
Nov. 22, 2022 (JP) 2022-186417

(51) Int. Cl. C21D 9/46; C22C 38/02; C22C 38/04

(52) U.S. Cl. CPC C21D 9/46; C22C 38/02; C22C 38/04; C21D 2201/05

(57) ABSTRACT

Grain-oriented electrical steel sheet further reduced in core loss by controlling the shape of its grooves to within a certain range for magnetic domain refining, that is, grain-oriented electrical steel sheet comprising steel sheet having a steel sheet surface formed with grooves extending in a direction crossing a rolling direction and having a groove depth direction comprised of a sheet thickness direction, having groove groups comprised of pluralities of grooves arranged in a sheet width direction when viewing the steel sheet surface from the sheet thickness direction, a plurality of the groove groups arranged at intervals in the rolling direction, in which grain-oriented electrical steel sheet, in 75% or more of the groove groups among the groove groups, an average width of the grooves forming each groove group being 42 to 62 μm, the grooves forming each groove group being arranged so as to overlap adjoining grooves on a projection plane parallel to the direction of extension of the grooves and the groove depth direction, an overlap between a first groove end of a second groove and a second groove end of a first groove in the projection plane is 5 to 30 mm, and a waviness of edges of the grooves forming each groove group is 0.5 to 5.0 μm.

### FIELD

The present invention relates to grain-oriented electrical steel sheet, in particular grain-oriented electrical steel sheet excellent in core loss property after stress relief annealing.

### BACKGROUND

Grain-oriented electrical steel sheet is being used as magnetic cores in numerous electrical equipment. Grain-oriented electrical steel sheet is steel sheet containing Si in about 1.0% to 5.0% and having a crystal orientation of the product controlled to the {110}<001> orientation to a high degree. Grain-oriented electrical steel sheet is excellent in magnetic properties and, for example, is utilized as the core material of transformers and other stationary inductors. For that purpose, as magnetic properties, a high magnetic flux density as represented by the B₈ value and a low core loss as represented by W17/50 are demanded.

Various technical development efforts are under way for improving the magnetic properties of such grain-oriented electrical steel sheet. In particular, along with the recent demand for energy savings, further lower core loss is being sought from grain-oriented electrical steel sheet. For reducing the core loss of grain-oriented electrical steel sheet, it is effective to raise the sharpness degree of the orientation of the crystal grains of steel sheet to the Goss orientation to improve the magnetic flux density and decrease the hysteresis loss.

In grain-oriented electrical steel sheet used as a base material for a wound transformer, in particular further lower core loss is being sought. For reducing the core loss, in electrical steel sheet, magnetic domain refining is being performed, but in a wound transformer, stress relief annealing is performed in the production process, so if performing magnetic domain refining, art for a heatproof magnetic domain refining would be necessary.

For example, as disclosed in PTL 1, it is widely known to use the laser irradiation method to be able to form grooves in a steel sheet surface relatively easily and stably and thereby control the magnetic domains.

PTL 2 discloses grain-oriented electrical steel sheet having grooves which is excellent in productivity and improved in core loss when forming grooves in the steel sheet surface.

### CITATIONS LIST

### Patent Literature

[PTL 1] WO 2016/1711124
[PTL 2] WO2016/1711129

### SUMMARY

### Technical Problem

The grain-oriented electrical steel sheet used as the base material for wound transformers is being required to be made further lower in core loss. Heatproof magnetic domain refining is generally being performed for forming linear shaped grooves or for introducing strain so that 180° domain widths are divided and along with this the eddy current loss which forms part of the core loss is reduced. However, there is demand for further lower core loss.

The present invention was made considering the above technical problem. It has as its object performing magnetic domain refining by controlling the shapes of the grooves to within certain ranges so as to further reduce the core loss of the obtained grain-oriented electrical steel sheet.

### Solution to Problem

The inventors found that the shape of a groove (in particular, the groove width and the waviness of the groove edge forming the boundary line of the steel sheet surface and groove) and the overlap of adjoining grooves have an effect on the core loss and came up with the idea of the present invention enabling reduction of core loss by limiting these amounts.

The gist of the present invention lies in
grain-oriented electrical steel sheet comprising steel sheet having a steel sheet surface formed with grooves extending in a direction crossing a rolling direction and having a groove depth direction comprised of a sheet thickness direction,
having groove groups comprised of pluralities of grooves arranged in a sheet width direction when viewing the steel sheet surface from the sheet thickness direction,
a plurality of the groove groups arranged at intervals in the rolling direction,
in which grain-oriented electrical steel sheet,
in 75% or more of the groove groups among the groove groups,
an average width of the grooves forming each groove group being 42 to 62 μm,
the grooves forming each groove group being arranged so as to overlap adjoining grooves on a projection plane parallel to the direction of extension of the grooves and the groove depth direction,
in the grain-oriented electrical steel sheet,
when designating an end part of the steel sheet in the sheet width direction as a benchmark edge of the sheet and designating adjoining grooves among the plurality of grooves of each groove group as a first groove and second groove in order of nearness from the benchmark edge of the sheet and
designating the two groove ends in the direction of extension of each groove (longitudinal direction) at each groove forming each groove group as a first groove end and second groove end in order of nearness from the benchmark edge of the sheet,
an overlap between a first groove end of a second groove and a second groove end of a first groove in the projection plane is 5 to 30 mm, and
a waviness of edges of the grooves forming each groove group is 0.5 to 5.0 μm.

### Advantageous Effects of Invention

According to the present invention, it was learned that the shapes of the grooves (in particular, the groove widths and the waviness of the groove edges forming the boundary lines of the steel sheet surface and grooves) and the overlap of adjoining grooves have an effect on the core loss. The amounts of these are limited so as to eliminate pinning at the time of magnetic domain movement and thereby reduce the core loss.

### BRIEF DESCRIPTION OF DRAWINGS

FIG. 1 is a schematic view showing grooves formed in a steel sheet surface of grain-oriented electrical steel sheet according to one embodiment of the present invention.

FIG. 2 is a view showing a cross-sectional shape of a groove (long direction) at an A-A line of FIG. 1.

FIG. 3 is a view showing a cross-sectional shape of a groove (short direction) at a B-B line shown in FIG. 1.

FIG. 4 is an explanatory view relating to the definition of a groove.

FIG. 5 is an explanatory view relating to the definition of a groove.

FIG. 6 is an explanatory view relating to the definition of a groove.

FIG. 7 is an explanatory view relating to the definition of a groove.

FIG. 8 is a view showing groove long projections of adjoining grooves of grain-oriented electrical steel sheet according to the present embodiment.

FIG. 9 is a view showing a relationship between an average width of a groove and the waviness of an edge of a groove.

FIG. 10 is a view showing a relationship between an overlap of adjoining grooves and the waviness of an edge of a groove.

### DESCRIPTION OF EMBODIMENTS

Below, preferred embodiments of the present invention will be explained in detail. Note that, unless particularly indicated otherwise, for numerical values A and B, the expression “A to B” shall mean “A or more and B or less.” In such expressions, when only the numerical value B is given a unit, that unit shall also be deemed to apply to the numerical value A.

### [Steel Sheet of Grain-Oriented Electrical Steel Sheet]

First, the grain-oriented electrical steel sheet according to the present embodiment is not particularly limited. Grain-oriented electrical steel sheet comprised of known steel constituents can be used. Such steel sheet able to be used for the grain-oriented electrical steel sheet according to the present invention will be explained illustratively below:

### [Chemical Composition of Steel Sheet]

A typical chemical composition of steel sheet will be explained below. Note that, below, unless particularly indicated otherwise, the expression of “%” shall indicate “mass %.”

The constituents of the steel sheet used for the grain-oriented electrical steel sheet according to the invention are constituents preferable for control to a Goss texture where the crystal orientations are integrated to the {110}<001> orientation and can contain at least Si: 1.0 to 5.0% and Mn: 0.01 to 0.15%.

### (Si: 1.0 to 5.0%)

The content of Si (silicon) is 1.0 to 5.0%. Si raises the electrical resistance of steel sheet and thereby reduces the eddy current loss-one of the causes of core loss. If the content of Si is less than 1.0%, it becomes difficult to sufficiently suppress the eddy current loss of the final grain-oriented electrical steel sheet, so this is not preferable. If the content of Si is more than 5.0%, the workability of the grain-oriented electrical steel sheet falls, so this is not preferable. Therefore, the content of Si is 1.0 to 5.0%, preferably is 2.50 to 4.50%, more preferably 2.70 to 4.00%.

### (Mn: 0.01 to 0.15%)

The content of Mn (manganese) is 0.01 to 0.15%. Mn forms the inhibitors MnS and MnSe, etc. affecting the secondary recrystallization. If the content of Mn is less than 0.01%, the absolute amounts of MnS and MnSe for causing secondary recrystallization are not reached, so this is not preferable. If the content of Mn is more than 0.15%, at the time of slab heating, dissolution of Mn becomes difficult, so this is not preferable. Further, if the content of Mn is more than 0.15%, the precipitated sizes of the inhibitors MnS and MnSe easily become coarser and the optimal size distributions as inhibitors are impaired, so this is not preferable. Therefore, the content of Mn is 0.01 to 0.15%, preferably is 0.03 to 0.13%.

The constituents other than Si and Mn can be the constituents contained in ordinary grain-oriented electrical steel sheet.

For example, as constituents other than Si and Mn, by mass %, C: 0.085% or less, acid soluble Al: 0.065% or less, N: 0.012% or less, Cr: 0.30% or less, Cu: 0.40% or less, P: 0.50% or less, Sn: 0.30% or less, Sb: 0.30% or less, Ni: 1.000% or less, and S: 0.0150% or less may be included. Further, as other inhibitor forming elements, B, Bi, Se, Pb, Sn, Ti, etc. can also be added. The amounts added may be suitably adjusted. The upper limit of the B content may be 0.080%, the upper limit of the Bi content may be 0.010%, the upper limit of the Se content may be 0.035%, the upper limit of the Pb content may be 0.10%, the upper limit of the Sn content may be 0.10%, and the upper limit of the Ti content may be 0.015%. These optional elements may be included in accordance with known objectives, therefore there is no need to establish lower limit values of the contents of the optional elements. For example, the lower limit values may also be 0%.

The balance besides the above constituents of the steel sheet is comprised of Fe and impurities. Here, “impurity” elements indicate constituents included in the raw materials or constituents entering in the process of production and allowed in a range not substantially impacting the present embodiment.

The chemical composition of steel sheet can be measured using ICP-AES (inductively coupled plasma-atomic emission spectrometry). Specifically, a 35 mm square test piece taken from the steel sheet is measured by an ICPS-8100 made by Shimadzu, etc. (measurement device) under conditions based on a calibration curve prepared in advance, so as to identify the chemical composition. Note that the C and S can be measured using the infrared absorption method after combustion while the N can be measured using the thermal conductimetric method after fusion in a current of inert gas.

### [Grooves]

Below, referring to the drawings, the grooves according to an embodiment of the present invention will be explained. However, the present invention is not limited to the configuration disclosed in the present embodiment and can be changed in various ways within a scope not departing from the gist of the present invention.

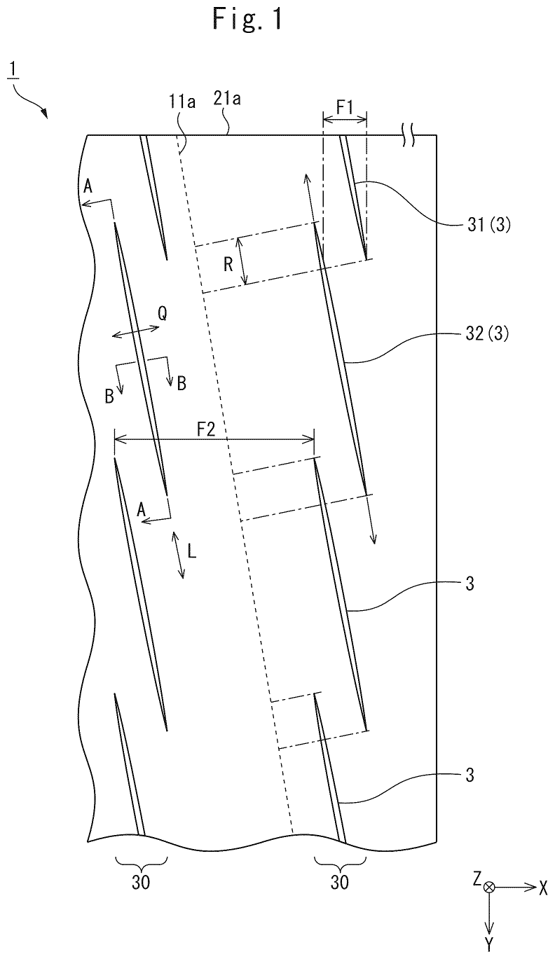

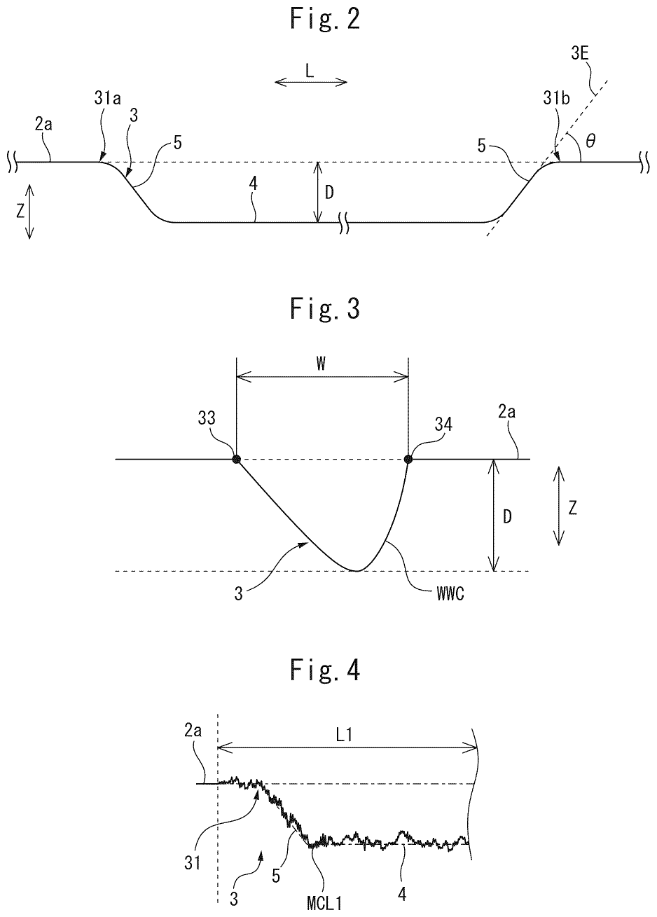

FIG. 1 is a plan view of grain-oriented electrical steel sheet 1 according to the present embodiment. FIG. 2 is an arrow view along the A-A line of FIG. 1. Note that, in the figures, the rolling direction of the grain-oriented electrical steel sheet 1 is defined as “X”, the sheet width direction of the grain-oriented electrical steel sheet 1 (direction orthogonal to rolling direction in same plane) as “Y”, and the sheet thickness direction of the grain-oriented electrical steel sheet 1 (direction orthogonal to XY plane) as “Z”. The grain-oriented electrical steel sheet 1 according to the present embodiment has grooves 3 at the steel sheet surface 2a for magnetic domain refining. FIG. 1 is a schematic view showing grooves 3 when viewing the grain-oriented electrical steel sheet according to the present embodiment from the sheet thickness direction Z (below, sometimes described as “planarly”).

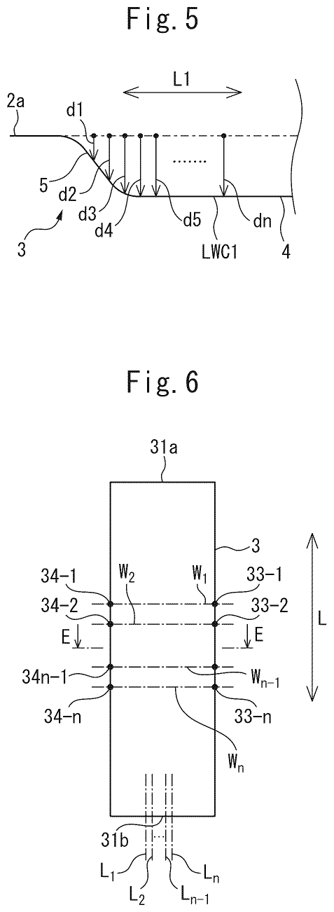

As shown in FIG. 1, when viewing a groove 3 from the sheet thickness direction Z (when viewing the groove 3 planarly), the direction of extension of the groove 3 (arrow mark L shown in FIG. 1) will be called the “groove long direction L”. When viewing the groove 3 planarly, the direction orthogonal to the groove long direction L of the groove 3 (arrow mark Q shown in FIG. 1) will be referred to as the “groove width direction Q”. The steel sheet surface 2a and grooves 3 of actual grain-oriented electrical steel sheet do not have uniformly formed surfaces, but for explaining the features of the invention, in FIG. 1 to FIG. 3 and FIG. 5 to FIG. 8, at least parts are shown schematically. Further, the grooves 3 may also have bow shapes when viewed from the sheet thickness direction Z (when viewing the grooves 3 planarly). However, in the present embodiment, for convenience of explanation, grooves 3 having linear shapes are illustrated.

The grain-oriented electrical steel sheet 1 is provided with a steel sheet (base iron) 2 controlled in crystal orientation by a combination of cold rolling and annealing so that the easy magnetization axis of the crystal grains and the rolling direction X match and has grooves 3 at the surface of the steel sheet 2 (steel sheet surface 2a).

The grooves 3, as shown in FIG. 1, are formed so as to extend in a direction crossing the rolling direction X and to have a depth direction comprised of the sheet thickness direction Z. When viewed from the sheet thickness direction Z to the steel sheet surface 2a, the grain-oriented electrical steel sheet 1 has groove groups 30 comprised of pluralities of grooves 3 arranged in the sheet width direction Y. A plurality of the groove groups is arranged at intervals in the rolling direction. The directions of extension of the grooves 3 are not particularly limited, but when designating the width direction Y as 0°, the angles formed by the directions of extension of the grooves 3 and the sheet width direction Y may be 0° to +60° in range. The grooves 3 forming each groove group 30 are approximately parallel. “Approximately parallel” means there may be several degrees of angular difference. For example, an angular difference of within ±5° or within ±3° is allowable.

In 75% or more of the groove groups among all of the groove groups, the grooves forming the groove groups can effectively improve the core loss by the average width of the grooves, the overlap of adjoining grooves, and the waviness of the edges of the grooves being in specific ranges. Note that the groove shapes are measured after removing from the final product the glass coating and insulation coating of at least the groove inside parts by pickling, etc.

The terms in the following explanation will be defined next.

### (Groove Average Depth D)

The “depth” of a groove 3 means, as shown in the example of FIG. 2, the length in the sheet thickness direction Z from the height of the steel sheet surface 2a to the surface (bottom part 4) of the groove 3. The groove average depth D may be measured as follows: When viewed from the sheet thickness direction Z (when viewing a groove 3 planarly), the examined range is set to part of the groove 3. The examined range is preferably set to a region excluding the end parts of the groove 3 in the groove long direction L (that is, to a region where the shape of the groove bottom is stable). For example, the examined range may be made the examined region at the substantial center part in the groove long direction L with a length in the groove long direction L of 30 μm to 300 μm or so. Next, a laser microscope is used to obtain the height distribution (groove depth distribution) in the examined range and find the maximum groove depth in this examined range. Similar measurement is performed changing the examined range to at least at three regions, more preferably to 10 regions. Further, the average value of the maximum depths at the examined regions is calculated and this defined as the groove average depth D. The groove average depth D of the grooves 3 in the present embodiment is preferably for example 5 μm or more and 100 μm or less to preferably obtain the effect of magnetic domain refining, more preferably more than 10 μm and 40 μm or less.

Note that, to measure the distance between the steel sheet surface 2a and the surface of a groove 3, it is necessary to measure in advance the position (height) of the steel sheet surface 2a in the sheet thickness direction Z. For example, it is possible to use a laser microscope to measure the position (height) in the sheet thickness direction Z for each of a plurality of locations at the steel sheet surface 2a in each observed range and utilize the average value of these measurement results as the height of the steel sheet surface 2a. Further, in the present embodiment, as explained later, when measuring the groove average width W, the groove short cross section is used, so the steel sheet surface 2a may also be measured from this groove short cross section. Note that, when examining a steel sheet sample by a laser microscope, it is preferable that the two sheet surfaces of the steel sheet sample (examined surface and its reverse surface) be approximately parallel.

### (Average Groove Width W)

The width of a groove 3, as shown in the example of FIG. 3, means the length of the groove opening in the groove short direction Q when viewing the groove 3 in a cross section crossing the groove long direction L (groove width direction cross section or groove short cross section). The average groove width W may be measured as follows: In the same way as the groove average depth D, when viewing the groove from the sheet thickness direction Z (when viewing the groove 3 planarly), the examined range is set to part of the groove 3. The examined range is preferably set to a region excluding the end parts of the groove 3 in the groove long direction L (that is, to a region where the shape of the groove bottom is stable). For example, the examined range may be made the examined region at the substantial center part in the groove long direction L with a length in the groove long direction L of 30 μm to 300 μm or so. Next, a laser microscope is used to obtain the groove short cross section crossing the groove long direction L at any one location in the examined range (for example, position of maximum groove depth at examined region). The length of the groove opening is found from the steel sheet surface 2a and the contour curve of the groove 3 appearing at the groove short cross section.

Specifically, if a low pass filter (cutoff value λs) is applied to a measured cross-sectional line MCL forming the steel sheet surface 2a and contour of the groove 3 appearing at the groove short cross section to obtain a cross-sectional curve, then a band filter (cutoff value λf, λc) is applied to the cross-sectional curve to remove the long wavelength component and short wavelength component from the cross-sectional curve, as shown in FIG. 3, a waviness curve WWC forming the contour of the groove 3 at the groove short cross section is obtained. The waviness curve is one type of contour curve applied for simplifying the shape of a contour by a smooth line.

As shown in FIG. 3, the length (groove opening) Wₙ of the line segment connecting two points (third point 33 and fourth point 34) separated by the groove 3 of the steel sheet surface 2a on the waviness curve WWC of the groove 3 at the groove short cross section is found.

Similar measurement is performed changing the examined range to at least three regions, more preferably to 10 regions. Further, the average value of the groove opening at the examined regions is calculated and this defined as the average groove width W. The average groove width W of a groove 3 in the present embodiment is for example 42 μm or more and 62 μm or less to preferably obtain the effect of magnetic domain refining.

Note that, to measure two separated points at a groove 3 of the steel sheet surface 2a (third point 33 and fourth point 34), it is necessary to measure in advance the positions (height) of the steel sheet surface 2a in the sheet thickness direction Z. For example, it is also possible to measure the position (height) in the sheet thickness direction Z for each of a plurality of locations at the steel sheet surface 2a on the waviness curve in each groove short cross section and utilize the average value of these measurement results as the height of the steel sheet surface 2a.

### (Overlap of Grooves)

The grooves 3 forming each groove group 30 are arranged so that the grooves adjoining each other overlap when viewed by a projection plane parallel to the direction of extension of the grooves (or the groove long direction L) and the depth direction of the grooves (or sheet thickness direction Z) (cross section shown by broken line 11a of FIG. 1). Due to this configuration, in the grain-oriented electrical steel sheet 1, if forming a plurality of grooves 3 in the sheet width direction Y, it is possible to secure a state where grooves 3 are formed in the sheet width direction Y and to improve the core loss.

When designating one end part of a steel sheet in the sheet width direction Y as the benchmark edge of the sheet 21a, the plurality of grooves 3 forming each groove group 30 form a first groove 31, second groove 32, and n-th groove 3n in order of nearness from the benchmark edge of the sheet 21a. The first groove 31, second groove 32, n-th groove 3n, as shown in FIG. 1, are arranged so that the end parts of the grooves 3 adjoining each other overlap (are superposed) on a projection plane formed by a parallel direction of extension (or groove long direction L) and depth direction of the grooves (or sheet thickness direction Z).

Further, each groove group 30, as shown in FIG. 1, is arranged so as to be separated from other groove groups 30 in the rolling direction X.

If the grooves 3 are arranged so that the end parts of the grooves 3 adjoining each other overlap (are superposed) on a projection plane formed by a parallel direction of extension (or groove long direction L) and depth direction of the grooves (or sheet thickness direction Z), it is possible to effectively improve the core loss

If defining the plane formed by a parallel groove long direction L and sheet thickness direction Z as the “projection plane” and projecting on this projection plane the contour of a groove 3 in the groove long direction L, the contour in the groove long direction L projected on the projection plane is defined as the “groove longitudinal projection line LWP”. The groove longitudinal projection line LWP may be measured as follows: When viewing a groove 3 planarly from the sheet thickness direction Z (see FIG. 6), as the examined range, a region including the entirety of the groove 3 or a region including the end parts of the groove 3 (that is, the region from the start of the groove 3 in the groove long direction L to the region where the shape of the groove bottom becomes stable) is set. In this examined range, a plurality of imaginary lines running along the groove long direction L are virtually set. The imaginary lines L1 to Ln are made ones able to be set to any heights in the sheet thickness direction Z. Further, among the imaginary lines L1 to Ln, an imaginary line running along the groove long direction L and satisfying the condition of becoming maximum in average depth of the groove is selected as a groove base line BL. For example, as shown in FIG. 6, among the depths D1 to Dn obtained for the imaginary lines L1 to Ln, if the groove depth D2 is maximum, the imaginary line L2 is defined as the groove base line BL. The curve obtained when projecting on that projection plane the groove depth distribution along the selected imaginary line as the contour (waviness curve) of the groove 3 as a whole in the groove long direction L is defined as the “groove longitudinal projection line LWP”. Note that, as the examined range, it is preferable to set a region including the entireties of two grooves adjoining each other or a region including the overlapping end parts of two grooves adjoining each other (that is, a region including a region in which the shape of a groove bottom of one groove is stable, a region in which groove ends of two grooves adjoining each other overlap, and a region in which the shape of a groove bottom of the other groove is stable). The two groove ends in the groove long direction L at each groove forming each groove group 30 are designated as the first groove end and second groove end in order of nearness from the benchmark edge of the sheet 21a. FIG. 8 schematically shows the first groove end 31a and second groove end 31b of the first groove longitudinal projection line LWP1 of the first groove 31 and the first groove end 32a and second groove end 32b of the second groove longitudinal projection line LWP2 of the second groove 32. Note that, for explaining the relative positions of adjoining grooves in the groove long direction L, in FIG. 8, among the plurality of grooves 3 of the grain-oriented electrical steel sheet 1 according to the present embodiment, the description is given extracting only the two grooves 31, 32 adjoining each other in the groove long direction L.

The grain-oriented electrical steel sheet 1 according to the present embodiment, as shown in FIG. 1, has the second groove end 31b of the first groove 31 and the first groove end 32a of the second groove 32 adjoining each other in the groove long direction L arranged to overlap in the groove long direction L. In FIG. 1, the arrangement where the end parts do not overlap when viewing the first groove 31 and the second groove 32 adjoining each other in the groove long direction L from the sheet thickness direction Z is illustrated. However, the first groove 31 and the second groove 32 may also overlap in the end parts when viewed from the sheet thickness direction Z. For example, the first groove 31 and the second groove 32 may also be deemed a single groove if their end parts completely overlap when viewed from the sheet thickness direction Z.

The grooves adjoining each other are superposed in the groove long direction L so that the position in the groove long direction L of the first groove end 32a of the second groove 32 in the second groove longitudinal projection line LWP2 becomes more to the benchmark edge of the sheet 21a side than the position in the groove long direction L of the second groove end 31b of the first groove 31 in the first groove longitudinal projection line LWP1. As shown in FIG. 8, the span between the second groove end 31b of the first groove 31 and the first groove end 32a of the second groove 32 is a region R where the first groove 31 and the second groove 32 overlap in the groove long direction L.

The distance in the long direction L between the second groove end 31b of the first groove 31 and the first groove end 32a of the second groove 32 at the overlap region R will be referred to as the “overlap”. In the grain-oriented electrical steel sheet 1 according to the present embodiment, the “overlap” is 5 to 30 mm. In the grain-oriented electrical steel sheet 1, the core loss can be kept low by a plurality of grooves being formed in the groove long direction L and by the grooves 31, 32 adjoining each other overlapping with an “overlap” of 5 to 30 mm. If the overlap is less than 5 mm, the closer to the end parts of the grooves, the smaller the effect of magnetic domain refining and the harder it becomes for the domains to be refined. Therefore, the magnetic domains are not refined at the overlap parts and the effect of reduction of core loss cannot be expected. On the other hand, if the amount of overlap is more than 30 mm, locations where the pitch between grooves is narrow relatively increase. If the pitch between grooves is narrow, the magnetic domains are refined, but the magnetic walls become fixed at the groove parts and movement of the magnetic walls in accordance with external changes in the magnetic field becomes difficult. Due to this, the hysteresis loss forming the core loss becomes greater and the effect due to magnetic domain refining is canceled out. Therefore, the core loss increases and improvement of the magnetic properties cannot be expected. That is, by arranging a plurality of grooves 3 in the groove long direction L and making the two end parts of grooves adjoining each other suitably overlap in the groove long direction L, it is possible to improve the core loss in the same way as forming a single groove of uniform depth in the groove long direction L.

The separation distance in the rolling direction X between the first groove 31 and the second groove 32 adjoining each other in the sheet width direction Y (distance F1 shown in FIG. 1) may be set smaller than the separation distance in the rolling direction X between groove groups 30 adjoining each other in the rolling direction X (distance F2 shown in FIG. 1). When designating the groove group average depth of the plurality of grooves 31, 32 . . . 3n provided in the sheet width direction Y as DA, the first groove 31 and the second groove 32 may be arranged so that the distance between the first groove end 32a of the second groove 32 and the benchmark edge of the sheet 21a of the steel sheet 2 becomes shorter than the distance between the second groove end 31b of the first groove 31 and the benchmark edge of the sheet 21a of the steel sheet 2. Due to this, it is possible to arrange a plurality of grooves 3 in the sheet width direction Y and make the two end parts of the grooves 31, 32 adjoining each other overlap in the sheet width direction Y and it is possible to improve the core loss in the same way as forming a single groove of uniform depth in the sheet width direction Y.

### (Waviness of Edge of Groove)

The edge of a groove 3, that is, the ridgeline between a groove 3 and the steel sheet 2 (boundary line) does not necessarily have to be a straight line shape such as shown in FIG. 6 and sometimes will be a curved shape with waviness. Therefore, it is necessary to clarify the waviness of the edge of a groove when viewing the groove 3 from the sheet thickness direction Z (when viewing the groove 3 planarly). Below, the method of identification of the waviness of the edge of a groove when viewing the groove 3 planarly will be explained.

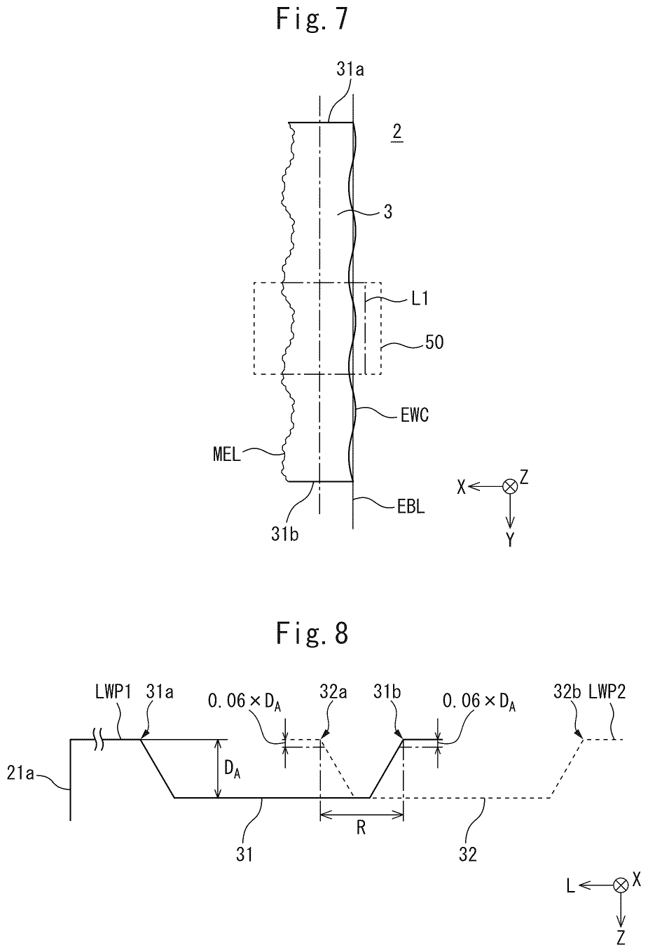

When viewing a groove 3 from the sheet thickness direction Z (when viewing the groove 3 planarly), if using a laser microscope, etc. to measure the edge of the groove 3 in the direction of extension of the groove, a measured edge curve MEL forming the edge of the groove 3 such as shown in FIG. 7 is obtained. Here, a point where the curve starts to fall from the position (height) of the steel sheet surface 2 toward the bottom of the groove is defined as a boundary between the groove 3 and steel sheet 2. The connected boundaries form a ridgeline (boundary line) of the groove 3 and steel sheet 2. The edge of the groove is defined by this. To measure the edge of a groove 3, that is, the ridgeline (boundary line) between the groove 3 and the steel sheet 2, it is necessary to measure in advance the position (height) of the steel sheet surface 2 in the Z direction. For example, it is also possible to measure the position (height) in the Z direction for each of a plurality of locations at the steel sheet surface 2 in the examined range 50 using a laser type surface roughness measuring device and utilize the average value of these measurement results as the height of the steel sheet surface 2. If a groove 3 is longer in direction of extension of the groove than the field of examination of a laser microscope, etc., the span from one end 31a to another end 31b of the groove 3 may be observed divided into several examined ranges 50. For example, the examined range 50 may be made an examined region with a length in the direction of extension of the grooves of 300 μm or so.

If a low pass filter (cutoff value λs) is applied to the measured edge curve MEL obtained in the above way to obtain an edge curve, then a band filter (cutoff value λf, λc) is applied to the edge curve to remove the long wavelength component and short wavelength component from the measured cross-sectional curve, as shown in FIG. 7, a waviness curve EWC forming the contour of the groove 3 at the groove extension direction of the groove 3 is obtained. The waviness curve is a contour curve applied for simplifying the shape of a contour by a smooth line. On the other hand, among the imaginary lines L1 to Ln, the imaginary line running along the groove long direction L and satisfying the condition that the difference from the measured edge curve MEL of the groove becomes minimal is selected as the edge base line EBL. For example, as shown in FIG. 6, for the imaginary lines L1 to Ln, the imaginary line Ln with a difference in displacement from the measured edge curve MEL becoming minimum by the least square method is defined as the edge base line EBL. As shown in FIG. 7, if using the difference between the edge base line EBL and the waviness line EWC, the waviness of the edge of a groove can be precisely evaluated.

### (Waviness Rag of Edge of Groove)

In the present embodiment the waviness of the edge of a groove is 0.5 to 5.0 μm. If the waviness Rag of the edge of a groove is less than 0.5 μm, the action as a starting point for formation of magnetic domains is small and sometimes sufficient magnetic domain refining does not occur. Further, if the waviness of the edge of a groove is more than 5.0 μm, pinning occurs hindering domain wall movement at electrical steel sheet and lowering the core loss becomes difficult.

The waviness of the edge of a groove can be defined by the following formula (1).

$$\begin{matrix}[ Mathematical 1 ] & \\ Rag = \frac{1}{ℓ} {\int }_{0}^{ℓ} f ( x ) dx & ( 1 )\end{matrix}$$

where, Rag is the waviness of the edge of the groove (μm), l is the length in the groove long direction, x is any position in the groove long direction, and f(x) is the difference between an edge base line EBL of the groove and the waviness curve EWC forming the contour of the edge.

### [Method of Production of Grain-Oriented Electrical Steel Sheet]

The process of production of the grain-oriented electrical steel sheet of the present invention will be explained illustratively below. Note that the method of production of the grain-oriented electrical steel sheet according to the present embodiment is just one example and may be changed in any way to an extent not impeding the effect of the present embodiment.

### (Casting Step S1)

In the casting step S1, a slab is prepared. One example of the method of production of a slab is as follows: First, molten steel is produced (smelted). Next, the molten steel is used to produce a slab. The method of production of the slab is not particularly limited, but, for example, continuous casting may be used for producing the slab. Molten steel may also be used to produce an ingot and the ingot bloomed to produce a slab. The thickness of the slab is not particularly limited. The thickness of the slab may, for example, also be 150 mm to 350 mm. The thickness of the slab is preferably 220 mm to 280 mm. As the slab, a thickness 10 mm to 70 mm so-called “thin slab” may be used. If using a thin slab, at the hot rolling step S2, the rough rolling before the finish rolling may be omitted.

The chemical composition of the slab need only be a chemical composition giving rise to secondary recrystallization. The basic composition and optional elements of the slab specifically explained become as follows: Note that the indications of “%” used for the constituents mean “mass %.”

Si is an important element in raising the electrical resistance and lowering the core loss. If the content is more than 5.0%, at the time of cold rolling, the material easily cracks and rolling becomes impossible. On the other hand, if lowering the amount of Si, at the time of finish annealing, α→γ transformation occurs and the orientation of the crystals becomes impaired, so 1.0% not affecting the orientation of the crystals in the finish annealing may be made the lower limit. Therefore, the Si content may be 1.0 to 5.0%

Mn and S precipitate as MnS which acts as an inhibitor. If the Mn content is less than 0.01% or the S content is less than 0.005%, there is a possibility that a predetermined amount of effective MnS inhibitor cannot be secured. Further, if the Mn content is more than 0.150% and the S content is more than 0.150%, there is a possibility that dissolution at the time of slab heating becomes insufficient and the secondary recrystallization no longer stably occurs. For this reason, the Mn content may be 0.01 to 0.15% and the S content may be 0.005 to 0.150%.

C is an element effective for control of the primary recrystallized structure in the production process, but has a possibility of detrimentally affecting the magnetic properties if the content in the final product is excessive. Therefore, the C content may also be made 0.085% or less. The preferable upper limit of the C content is 0.080%. C is removed at the later explained decarburization annealing step S5 and the final annealing step S8 and becomes 0.005% or less after the final annealing step S8. If the slab contains C, considering the productivity at the time of industrial production, the lower limit of the C content may be more than 0% and may be 0.001%.

Acid soluble Al is an element bonding with N to form AlN or (Al,Si) N and functioning as an inhibitor in that state. The content of the acid soluble Al may be made 0.012% to 0.065% by which the magnetic flux density becomes higher.

N is an element by which, when added in 0.012% or more at the time of steelmaking, forms cavities in the steel sheet called “blisters,” so the upper limit of the N content may be 0.012%. N can be included by nitriding in the middle of the production process, so the lower limit is not particularly prescribed and may also be 0%. However, the detection limit of N is 0.0001%, so the substantive lower limit is 0.0001%.

The slab can have added to it B, Bi, Se, Pb, Sn, Ti, etc. as other inhibitor forming elements. The amounts added may be suitably adjusted. The upper limit of the B content may be 0.080%, the upper limit of the Bi content may be 0.010%, the upper limit of the Se content may be 0.035%, the upper limit of the Pb content may be 0.10%, the upper limit of the Sn content may be 0.10%, and the upper limit of the Ti content may be 0.015%. These optional elements may be included in accordance with known objectives, therefore there is no need to establish lower limit values of the contents of the optional elements. For example, the lower limit values may also be 0%.

The balance of the chemical composition of the slab is comprised of Fe and impurities. Note that the “impurities” referred to there are constituents entering the slab due to the ore, scrap, or other raw materials and other various factors in the production process when industrially producing the slab and which are allowed to an extent not substantially having an effect on the grain-oriented electrical steel sheet according to the present invention.

Any known element may be included (added) in place of part of the Fe considering the strengthening of the inhibitor function by formation of compounds and the effect on the magnetic properties. As the any element to be included in the slab in place of part of the Fe, for example, Cu, P, Sb, Sn, Cr, Ni, etc. may be mentioned. One or more of any of these may be added to the slab. The upper limit value of the Cu content may be 0.3%, the upper limit value of the P content may be 0.5%, the upper limit value of the Sb content may be 0.3%, the upper limit value of the Sn content may be 0.3%, the upper limit value of the Cr content may be 0.30%, and the upper limit value of the Ni content may be 1.0%. These optional elements may be included in accordance with known objectives, therefore there is no need to establish lower limit values of the contents of the optional elements. For example, the lower limit values may also be 0%.

The chemical composition of the slab can be measured using ICP-AES (inductively coupled plasma-atomic emission spectrometry). Specifically, a 35 mm square test piece taken from the slab is measured by an ICPS-8100 made by Shimadzu, etc. (measurement device) under conditions based on a calibration curve prepared in advance, so as to identify the chemical composition. Note that the C and S can be measured using the infrared absorption method after combustion while the N can be measured using the thermal conductimetric method after fusion in a current of inert gas.

### (Hot Rolling Step S2)

The hot rolling step S2 is a step of hot rolling a slab heated up to a predetermined heating temperature (for example, 1100 °C to 1400 °C) to obtain hot rolled steel sheet. The heating temperature at the time of hot rolling may, for example, be 1100 °C or more from the viewpoint of securing the temperature at the time of hot rolling and further may be 1280 °C or less from the viewpoint of not causing complete dissolution of the inhibitor constituent AlN. Note that if making AlN and MnS the main inhibitors, the heating temperature at the time of hot rolling may be made the 1300 °C or more where these inhibitor constituents completely dissolve.

### (Hot Rolled Steel Sheet Annealing Step S3)

The hot rolled steel sheet annealing step S3 is a step for annealing the hot rolled steel sheet obtained at the hot rolling step S2 immediately or after a short time to obtain annealed steel sheet. The annealing may be performed a 750 °C to 1200 °C in temperature region for 30 seconds to 30 minutes. The annealing is effective for raising the magnetic properties of the product.

### (Cold Rolling Step S4)

The cold rolling step S4 is a step for cold rolling one time the annealed steel sheet obtained at the hot rolled steel sheet annealing step S3 or cold rolling it several times (two times or more) interspaced with annealing (process annealing) (for example, for a total cold rolling rate of 80% to 95%) to obtain cold rolled steel sheet. The thickness of the cold rolled steel sheet may for example be 0.10 mm to 0.50 mm.

### (Decarburization Annealing Step S5)

The decarburization annealing step S5 is a step for annealing the cold rolled steel sheet obtained at the cold rolling step S4 for decarburization and for obtaining a decarburized annealed steel sheet with primary recrystallization (cold rolled steel sheet subjected to decarburization annealing step). The decarburization annealing may be performed at for example 700 °C to 900 °C for 1 minute to 3 minutes.

By annealing the cold rolled steel sheet for decarburization, the C constituent contained in the cold rolled steel sheet is removed. For removing the C constituent contained in the cold rolled steel sheet, the decarburization annealing is preferably performed in a wet atmosphere.

### (Nitriding Step S6)

The nitriding step S6 is a step performed in accordance with need for adjusting the strength of an inhibitor in secondary recrystallization. Nitriding is treatment for making the amount of nitrogen of cold rolled sheet increase to 40 ppm to 200 ppm or so from the start of the decarburization annealing step to the start of the secondary recrystallization in the finish annealing step. As the nitriding, for example, treatment for annealing the decarburized annealed steel sheet in an atmosphere containing ammonia or other nitriding gas, treatment for coating an annealing separator containing powder of MnN, etc. having a nitriding ability on the decarburized annealed steel sheet at the later explained annealing separator coating step S7, etc. may be mentioned.

### (Annealing Separator Coating Step S7)

The annealing separator coating step S7 is a step of coating the decarburized annealed steel sheet with an annealing separator. As the annealing separator, for example, an annealing separator having alumina (Al₂ O₃) as its main constituent can be used. The decarburized annealed steel sheet after coating by the annealing separator is wound up into a coil and in that state is finish annealed at the next finish annealing step S8.

Note that, if forming a glass coating containing Mg₂ SiO₄, an annealing separator having magnesia (MgO) as its main constituent is used.

### (Finish Annealing Step S8)

The finish annealing step S8 is a step of finish annealing the decarburized annealed steel sheet on which the annealing separator was coated so as to cause secondary recrystallization. This finish annealing step S8 accompanied with secondary recrystallization causes progression of secondary recrystallization in a state suppressing growth of primary recrystallized grains by an inhibitor so as to make the {100}<001> oriented grains preferentially grow and cause the magnetic flux density to be strikingly improved.

Note that, in the above-mentioned annealing separator coating step S7, if coating magnesia (MgO), a glass coating containing Mg₂ SiO₄ is formed by this finish annealing step S8. Note that, in this embodiment, such a glass coating is also deemed included in the base steel sheet (later explained finish annealed steel sheet). Therefore, for example, if the finish annealed steel sheet is formed with a glass coating, the “surface of the finish annealed steel sheet” is deemed to mean the surface of the glass coating. By forming the glass coating, the properties of the finally obtained grain-oriented electrical steel sheet can be expected to be further enhanced.

### (Groove Forming Step S9)

The groove forming step S9 is a step for forming grooves in the steel sheet for the purpose of magnetic domain control (magnetic domain refining). The grooves can be formed by laser, electron beam, plasma, mechanical method, etching, or other known technique.

In the flow explained above, the groove forming step S9 is performed after the finish annealing step S8. However, the groove forming step S9 may also be performed at the steel sheet after the cold rolling step S4 (that is, the cold rolled steel sheet). In this case as well, it is possible to maintain the ideal cross-sectional shape of the linear groove G by magnetic domain refining. Therefore, the time at which the groove forming step S9 is performed may be before or after the finish annealing step S8. However, if performing the later explained insulation coating forming step S10, it is necessary to perform the groove forming step S9 before that step S10.

If forming the grooves using a laser, it is possible to obtain the electrical steel sheet according to the present embodiment by the example of the laser irradiation conditions below.

In the laser irradiation step, the surface of the steel sheet (only one surface) may be lasered to form on the surface of the steel sheet a plurality of grooves extending in a direction crossing the rolling direction at a 2 to 20 mm range of desired pitch along the rolling direction.

In the laser irradiation step, the laser irradiation apparatus may emit a laser beam toward the surface of the steel sheet by driving rotation of a polygon mirror and make the laser beam scan a direction forming a 0 to 30° angle with the direction perpendicular to rolling.

At the same time as the laser irradiation, a water jet may be sprayed at the portion of the steel sheet which is lasered. With a water jet, it is possible to give rise to the action of washing, peeling, cutting, etc. the portion concerned by an ultrahigh speed water flow of water pressurized by a high pressure water pump ejected from a nozzle being made to strike a portion concerned. The pressurization may be made 50 to 350 MPa and the nozzle may be a size of 0.1 mm to 1 mm or so. An abrasive (sandblast garnet, etc.) may also be added to the solvent (water). The grade, particle size (#), etc. of the abrasive can be suitably selected. The particle size (#) may be 10 to 1000 in range. The water jet performs the role of removing constituents melted or vaporized from the steel sheet due to the laser irradiation. By spraying the water jet, it is possible to keep the molten or vaporized constituents from remaining in the grooves and possible to stably form the grooves keeping the waviness of the edges of the grooves in the desired range.

At the same time as the laser irradiation, air or an inert gas or other assist gas may be blown at the portion of the steel sheet which is lasered. The inert gas is, for example, nitrogen, argon, etc. The assist gas acts to remove the constituents melted or vaporized from the steel sheet due to laser irradiation. By blowing the assist gas, the laser beam reaches the steel sheet without being obstructed by the melted or vaporized constituents, so the grooves are stably formed.

As the laser source, for example, a fiber laser, YAG laser, semiconductor laser, or CO₂ laser or other high output laser generally used for industrial purposes can be used. Further, so long as it is possible to stably form the grooves, a pulse laser or continuous wave laser may also be used as the laser source. As the laser, the general practice is use of a single mode laser high in focusing ability for formation of grooves, but a multimode laser with suitably distributed power peaks may also be used.

As one example of laser irradiation, for example, it is possible to make the laser output 200 W to 3000 W to change the beam shape of the laser when forming the grooves.

The focused spot size of the laser (that is, the diameter including 86% of the laser output, below sometimes described abbreviated as the “86% diameter”) may be set to 10 μm to 1000 μm, the laser scan speed may be set to 1 m/s to 100 m/s, and the laser scan pitch (pitch PL) may be set to 2 mm to 10 mm. These laser irradiation conditions are suitably adjusted so that the desired grooves are obtained.

### (Tension Coating Forming Step S10)

The tension coating forming step S10 is a step of coating a groove forming surface of finish annealed steel sheet with a coating solution and baking it on so as to form an insulation coating (tension coating) on the groove forming surface. By forming an insulation coating (tension coating), the properties of the finally obtained grain-oriented electrical steel sheet can be expected to be further improved.

Here, the coating solution contains, for example, phosphoric acid, chrome anhydride, a chromate, alumina, or a silica compound. The baking may be performed under conditions of for example 350 °C to 1150 °C for 5 seconds to 300 seconds.

### EXAMPLES

Below, examples will be shown while explaining the grain-oriented electrical steel sheet of the present invention more specifically. Note that the examples shown below are just illustrations of the grain-oriented electrical steel sheet according to the embodiments. The grain-oriented electrical steel sheet according to the embodiments is not limited to the examples shown below.

A slab prepared to give grain-oriented electrical steel sheet having a chemical composition containing, by mass %, Si: 3.0%, C: 0.080%, acid soluble Al: 0.028%, N: 0.010%, Mn: 0.12%, Cr: 0.05%, Cu: 0.04%, P: 0.01%, Sn: 0.02%, Sb: 0.01%, Ni: 0.005%, S: 0.007%, and Se: 0.001% and having a balance comprised of Fe and impurities was hot rolled to obtain thickness 2.3 mm hot rolled steel sheet.

Next, the hot rolled steel sheet was annealed under temperature conditions of heating at 1000 °C for 1 minute.

After the annealing, the steel sheet was cold rolled to obtain thickness 0.23 mm cold rolled steel sheet. Next, this cold rolled steel sheet was annealed for decarburization under temperature conditions of heating at 800 °C for 2 minutes, then an annealing separator containing magnesia (MgO) as its main constituent was coated on the surface of the cold rolled steel sheet.

Next, the cold rolled steel sheet on which the annealing separator was coated was finish annealed under temperature conditions of heating at 1200 °C for 20 hours. As a result, steel sheet having the above-mentioned chemical composition, controlled in crystal orientation so that the easy magnetization axis of the crystal grains and rolling direction matched, and having a glass coating formed on its surface was obtained.

Next, the surface of the steel sheet was lasered to form grooves in the surface of the steel sheet while spraying a water jet under the conditions shown in Table 1. At the water jet, as an abrasive, sandblast garnet (high hardness garnet Type 2 (800-300 μm) made by Nicchu Co., Ltd.) was used.

The laser irradiation apparatus used was a fiber laser made by IPG. The laser irradiation conditions were adjusted to give a laser output of 300 W, a laser scan speed of 50 m/s, and a laser scan pitch (pitch PL) of 3 mm. The laser was adjusted to give a focused spot size of 50 μm. Linear grooves with a depth D of about 20 μm were formed at 3 mm intervals in a direction orthogonal to the rolling direction. The grain-oriented electrical steel sheet was produced so that groove groups with widths of grooves, overlap of adjoining grooves, and waviness of edges of the grooves adjusted to satisfy the conditions shown in Table 1 became 75% of all of the groove groups. Note that, the step of forming the grooves was performed either after finish annealing or after the cold rolling step.

The obtained electrical steel sheet was used to produce a capacity 25 kVA wound core. This was annealed to relieve stress (held at soaking temperature of 750 °C for 4 hours), then measured for core loss W17/50. The results are shown in Table 1.

### [Evaluation of Magnetic Properties]

For a wound core, measurement is performed using the excitation current method described in JIS C 2550-1:2011 under conditions of a frequency of 50 Hz and magnetic flux density of 1.7T so as to measure the core loss value (also referred to as the iron core or core iron loss”) WA of the wound core.

TABLE 1

| | | | | Average | | Waviness | | |
|---|---|---|---|---|---|---|---|---|
| | | | | width of | Overlay | of edges | Core loss | |
| | | Water jet spray | Abrasive | groove | of grooves | of grooves | W₁₇/₅₀ | |
| No. | Groove-forming step | pressure (MPa) | # | (μm) | (mm) | (μm) | (W/kg) | |
| 1 | After finish annealing | 100 | 20 | 25 | 2 | 7 | 0.88 | Comp. ex. |
| 2 | After finish annealing | 200 | 300 | 51 | 28 | 0.7 | 0.71 | Inv. ex. |
| 3 | After finish annealing | 300 | 480 | 81 | 40 | 0.3 | 0.85 | Comp. ex. |
| 4 | After cold rolling | 80 | 20 | 20 | 1 | 10 | 0.89 | Comp. ex. |
| 5 | After cold rolling | 150 | 300 | 49 | 25 | 0.8 | 0.72 | Inv. ex. |
| 6 | After cold rolling | 280 | 400 | 75 | 35 | 0.4 | 0.82 | Comp. ex. |
| 7 | After finish annealing | 200 | 20 | 51 | 28 | 7 | 0.83 | Comp. ex. |
| 8 | After finish annealing | 200 | 480 | 71 | 28 | 0.7 | 0.86 | Comp. ex. |
| 9 | After finish annealing | 200 | 300 | 51 | 48 | 0.7 | 0.81 | Comp. ex. |

| | | | | | | | |
|---|---|---|---|---|---|---|---|
| 10 | After finish annealing | No water jet; Laser output 3100 W, | 51 | 48 | 15 | 0.89 | Comp. ex. |
| | | Beam diameter 8 μm | | | | | |

From these results, it was judged that the wound cores test produced by electrical steel sheet within the scope of the present invention were good in magnetic properties and enabled the increase in core loss to be kept down. Specifically, when using a material with a core loss of 0.74 W/kg to fabricate a transformer type core, the actually measured core loss deteriorated. When setting the judgment criteria of the core loss to be not exceeding 0.80 W/kg, this was satisfied by conditions of No. 2 and No. 5.

Further, in No. 10, as an example of forming grooves by laser without spraying a water jet, grooves were formed by a laser output of 3100 W, a focused spot size of 8 μm, a laser scan speed of 1 m/s, and a laser scan pitch (pitch PL) of 2 mm. In this case, the waviness of the edges of the grooves became 15 μm and the core loss became a larger 0.89 W/kg.

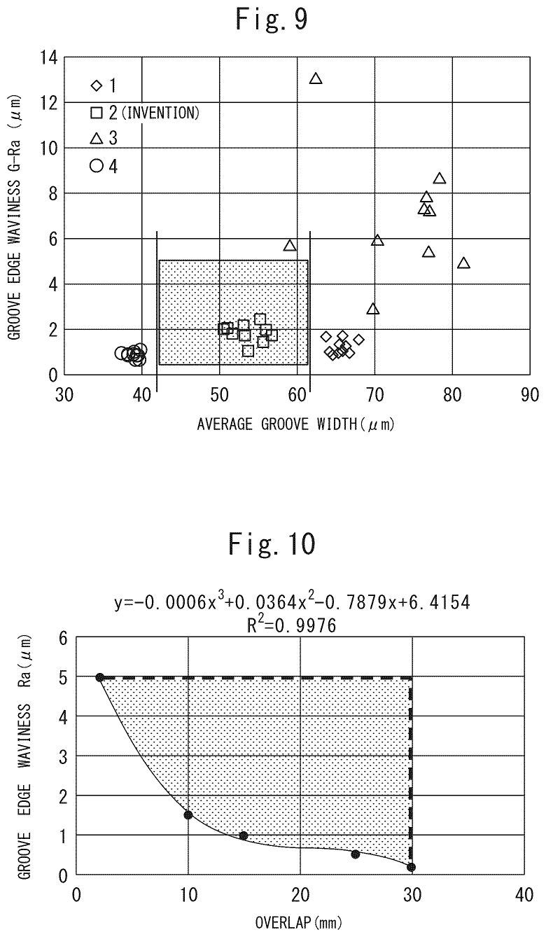

Separately, the inventors investigated the case of fixing the overlap of the adjoining grooves at 25 μm and changing the width of the grooves and waviness of the edges of the grooves. The results are shown in FIG. 9. In FIG. 9, it was confirmed that if the width of the grooves and waviness of the edges of the grooves are within the scope of the present invention, the magnetic properties are excellent. In this case as well, when using a material of 0.74 W/kg to measure the core loss, good magnetic properties not exceeding 0.80 W/kg were obtained.

Separately, the inventors investigated the case of fixing the width of the grooves at 50 μm and changing the overlap of adjoining grooves and waviness of the edges of the grooves. The results are shown in FIG. 10. In FIG. 10, it was confirmed that if the overlap of adjoining grooves and waviness of the edges of the grooves are within the scope of the present invention, the magnetic properties are excellent. In this case as well, when using a material of 0.74 W/kg to measure the core loss, good magnetic properties not exceeding 0.80 W/kg were obtained.

1. Grain-oriented electrical steel sheet comprising steel sheet having a steel sheet surface formed with grooves extending in a direction crossing a rolling direction and having a groove depth direction comprised of a sheet thickness direction,
having groove groups comprised of pluralities of grooves arranged in a sheet width direction when viewing the steel sheet surface from the sheet thickness direction,
a plurality of the groove groups arranged at intervals in the rolling direction,
in which grain-oriented electrical steel sheet,
in 75% or more of the groove groups among the groove groups,
an average width of the grooves forming each groove group being 42 to 62 μm,
the grooves forming each groove group being arranged so as to overlap adjoining grooves on a projection plane parallel to the direction of extension of the grooves and the groove depth direction,
in the grain-oriented electrical steel sheet,
when designating an end part of the steel sheet in the sheet width direction as a benchmark edge of the sheet and designating adjoining grooves among the plurality of grooves of each groove group as a first groove and second groove in order of nearness from the benchmark edge of the sheet and
designating the two groove ends in the direction of extension of each groove at each groove forming each groove group as a first groove end and second groove end in order of nearness from the benchmark edge of the sheet,
an overlap between a first groove end of a second groove and a second groove end of a first groove in the projection plane is 5 to 30 mm, and
a waviness of edges of the grooves forming each groove group is 0.5 to 5.0 μm.
